(19) United States
(12) Patent Application Publication
(10) Pub. No.: US 2008/0034910 A1
(43) Pub. Date: Feb. 14, 2008

(54) Dynamic adjustment of a steering system yoke

(76) Inventors: Eric A. Roline, Morristown, TN (US); Jagadish K. Peringat, Rogersville, TN (US); Robert Fought, Mt. Carmel, TN (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/501,410

(22) Filed: Aug. 9, 2006

(51) Int. Cl. F16H 35/00; F16H 1/04

(52) U.S. Cl. 74/422; 74/388 PS

(57) ABSTRACT

An apparatus for urging components of power steering system into engagement includes a rack including gear teeth, a pinion including gear teeth engaged with the gear teeth of the rack, a yoke bearing contacting the rack, a spring for resiliently contacting the yoke and urging the rack into engagement with the pinion, a source of variable hydraulic pressure communicating with the yoke bearing and applying to the yoke bearing a force that urges the rack into engagement with the pinion, and a valve that opens a connection between the pressure source and the yoke bearing at a first speed in response to a first pressure magnitude at the pressure source and that closes said connection at a second speed slower than the first speed when pressure at the pressure source decreases relative to the first pressure magnitude.

### BACKGROUND OF THE INVENTION

The present invention relates generally to a power steering system for a motor vehicle, in which a toothed rack is biased toward engagement with a pinion gear. More particularly, the invention pertains to adjusting the magnitude of a force that urges a yoke toward the rack to maintain the teeth on the pinion and rack in mutual engagement.

A rack and pinion steering assembly includes a rack, which is disposed in meshing engagement with a pinion. A housing encloses the rack and pinion. A yoke presses the rack toward the pinion to maintain meshing engagement between gear teeth on the rack and gear teeth on the pinion. In a power steering system, steering effort of the vehicle operator in displacing the rack is assisted by a hydraulically-actuated double acting piston, secured to the rack, and a hydraulic motor, the source of hydraulic pressure applied to the piston. The power steering system reduces the level of effort required by the vehicle operator to change the position of the steered wheels in response to changes in the angular position of the steering wheel controlled manually by the operator.

Because the gear teeth on the rack and pinion are helical teeth, the turning force transmitted between the engaged teeth has a component tending to force the rack teeth away from engagement with the pinion teeth. This force urges the rack and yoke to move away from the pinion against the effect of a spring force. In addition, impulse forces transmitted from the road surface to the assembly 10 due to the wheels hitting potholes, rocks or debris, etc., called “road events,” can also move the rack away from pinion in a direction transverse to a longitudinal central axis of the rack.

Empirical data show that road events not only create forces which are transferred through tie-rods to the rack assembly, but also induce hydraulic pressure events in the hydraulic motor due to movement of the rack assembly in response to road events. These pressure events can be measured using pressure transducers. Normally pressure in the tower hydraulic system is in the range of 15-75 psi., but road events can create brief pressure pulses over 300 psi. lasting about 5 ms.

It is conventional to rely on a compression spring to maintain a biasing force applied to the yoke and urging the rack to remain engaged with the pinion. In operation, however, the yoke bearing is susceptible to large loads induced by road surface imperfections tending to disengage the rack and the pinion. It is desirable to augment the spring force with hydraulic pressure force that would resist such disengagement. The spring force also increases frictional forces from the yoke to the rack, thereby reducing sudden movement of the rack.

It is desireable that this force be as low as possible so that it is easier for the driver to maneuver the vehicle. A continuously large force makes the steering gear harder to turn.

### SUMMARY OF THE INVENTION

In one embodiment a steering assembly for use in turning wheels of a vehicle includes a rack, a pinion, and a yoke continuously pressed against the rack by a yoke spring. A force, developed by hydraulic pressure and arranged in series with the spring, elastically resists displacement of the yoke away from the rack and urges the rack toward engagement with the rack. It is therefore, an advantage of this arrangement that energy produced by road events, which normally create forces that try to separate the rack teeth from the pinion teeth, is used to produce a pressure force that keep the pinion and rack teeth engaged, thereby reducing noise, vibration and harshness.

Hydraulic pressure for this purpose supplied to the yoke bore for energizing the yoke assembly, is carried from a location in the steering assembly where fluid flow from a hydraulic pump is directed by a control valve to the hydraulic motor and to a fluid reservoir. Alternatively, hydraulic tower pressure is supplied to the yoke bore from a return line port or supply line port. The hydraulic force (attack and decay) can be tuned by adjusting the supply line inside diameter, the size of an orifice in the supply line, or use of mechanical or electromechanical valves. A hydraulic auto adjustment feature reduces or eliminates yoke sensitivity to mechanical lash set during assembly.

An apparatus for urging components of power steering system into engagement includes a rack including gear teeth, a pinion including gear teeth engaged with the gear teeth of the rack, a yoke bearing contacting the rack, a spring for resiliently contacting the yoke and urging the rack into engagement with the pinion, a source of variable hydraulic pressure communicating with the yoke bearing and applying to the yoke bearing a force that urges the rack into engagement with the pinion, and a valve that opens a connection between the pressure source and the yoke bearing at a first speed in response to a first pressure magnitude at the pressure source and that closes said connection at a second speed slower than the first speed when pressure at the pressure source decreases relative to the first pressure magnitude.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The present invention will become more fully understood from the detailed description given below, the appended claims, and the accompanying drawings, in which:

FIG. 1 is a side view partially in cross section illustrating a rack and pinion steering assembly to which the present invention may be applied;

FIG. 2 is a cross section taken at plane 2-2 of FIG. 1 illustrating a first embodiment for dynamically adjusting a force that urges a yoke bearing and rack toward a pinion for maintaining the teeth on the pinion and rack in mutual engagement;

FIG. 3 is a cross section through the housing assembly showing a second embodiment for dynamically adjusting the magnitude of the force that urges the yoke bearing and rack toward a pinion;

FIG. 4 is a schematic diagram of an third embodiment for dynamically adjusting the magnitude of the force that urges the yoke bearing and rack toward a pinion; and

FIG. 5 is a cross section through a valve for regulating communication between the yoke bearing and a pressure source;

FIG. 6 is a graph showing transient pressure occurrences at the pressure source caused by road events; and

FIG. 7 is a graph showing the variation over time of hydraulic force on the yoke bearing due to transient pressures caused road events.

### DESCRIPTION OF THE PREFERRED EMBODIMENT

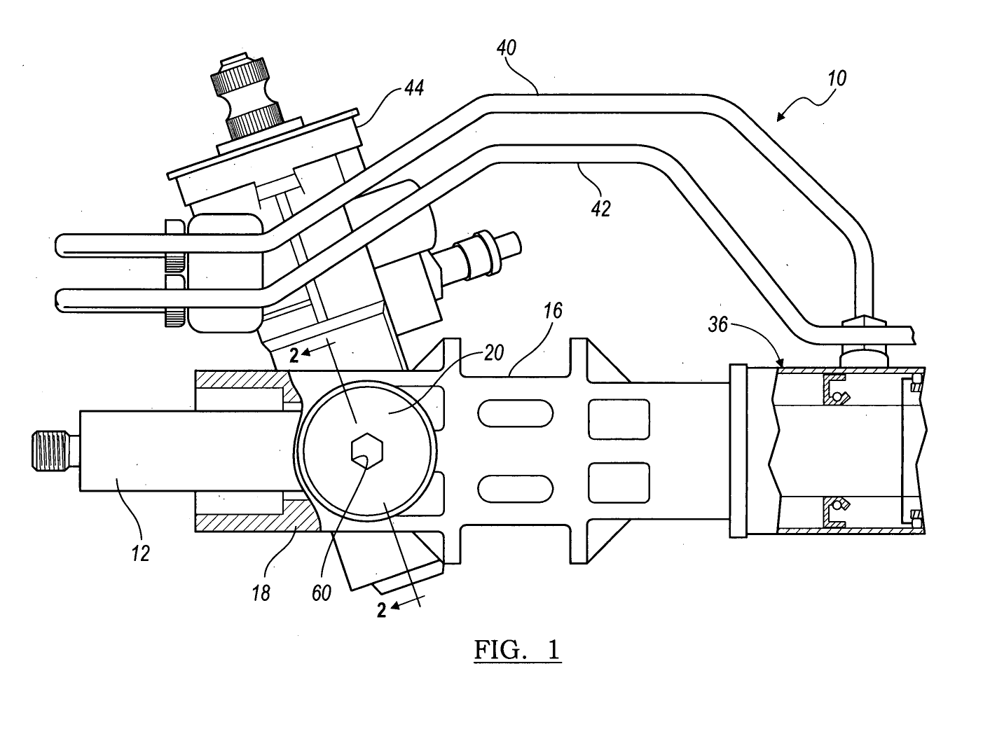

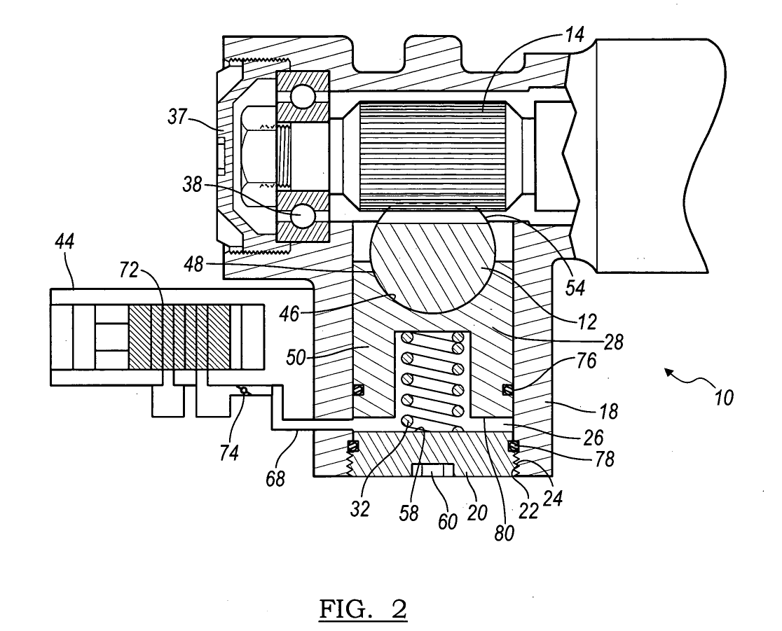

Referring first to FIGS. 1 and 2, a rack and pinion steering assembly 10 includes a rack 12, whose axially opposite ends are connected to vehicle wheels able to be steered by manual operation of a steering wheel by the vehicle operator. A pinion 14 has gear teeth in meshing engagement with teeth formed on the rack 12. A housing 16 enclosing the rack 12 and pinion 14 includes a cast main housing section 18. A circular yoke plug 20 having external threads 22, which engage internal threads 24 on the main section 18 of the housing, closes the upper end of a cylindrical yoke chamber 26 formed in the main housing section 18.

A yoke 28, located in the yoke chamber 26, contacts a helical coiled compression spring 32, disposed between the yoke 28 and the yoke plug 20. Alternatively, spring 32 may be an elastomeric element or a wave spring. The spring 32 presses the yoke 28 firmly against the rack 12 due to an elastic, resilient force produced by the spring.

The pinion 14 is supported for rotation on a bearing 38, fitted in the housing 16. A nut 37, threaded into the housing 16, locates the bearing correctly and secures it in the housing.

A fluid motor 36, connected to the rack 12, assists in turning the vehicle wheels. Rotation of the steering wheel of the vehicle actuates a steering control valve (not shown), which directs flow of hydraulic fluid to and from the fluid motor 36 through conduits 40, 42 in response to the directional sense of the steering wheel displacement. When the steering wheel is turned from a neutral or straight-ahead position, the control valve directs pressurized fluid from the outlet of a hydraulic pump through one of the conduits 40, 42 to one side of a piston located in the hydraulic motor, and it vents fluid through the other conduit from the opposite side of the piston to a pressure reservoir, from which the pump inlet is supplied with fluid. In either case, the pump outlet continually supplies pressurized fluid to the control valve, which is usually located in a tower 44, formed integrally with the housing 16.

The yoke 28 has an arcuate inner surface 46, which engages an arcuate outer surface 48 on the rack 12. The yoke spring 32 continually biases the arcuate inner surface 46 on the yoke 28 toward the outer surface 48 of the rack 12. The yoke 28 is formed with a wall 50, which engages a circular cylindrical inner surface of the chamber 26 of main housing section 18. The yoke wall 50 is formed with a circular cylindrical outer surface.

The yoke plug 20 includes a flat circular inner surface 58, which faces the end surface of the yoke 28. A hexagonal socket 60 formed on the outer surface of the plug 20 can be engaged by a wrench, or a similar turning device, to install and remove the plug from the main housing section 18.

A hydraulic line 68 connects chamber 26 with a source of pressurized hydraulic fluid from the top or bottom of the control tower 44. Alternatively, chamber 26 is hydraulically connected through line 68 to the hydraulic lines that carry fluid from a power steering pump outlet to control valve 72, or fluid from the control valve to a fluid reservoir, from which the pump inlet is supplied with fluid. In either case, pressure of the fluid in line 68 rises and falls in response to road events transmitted from the vehicle tie rods to the rack 12.

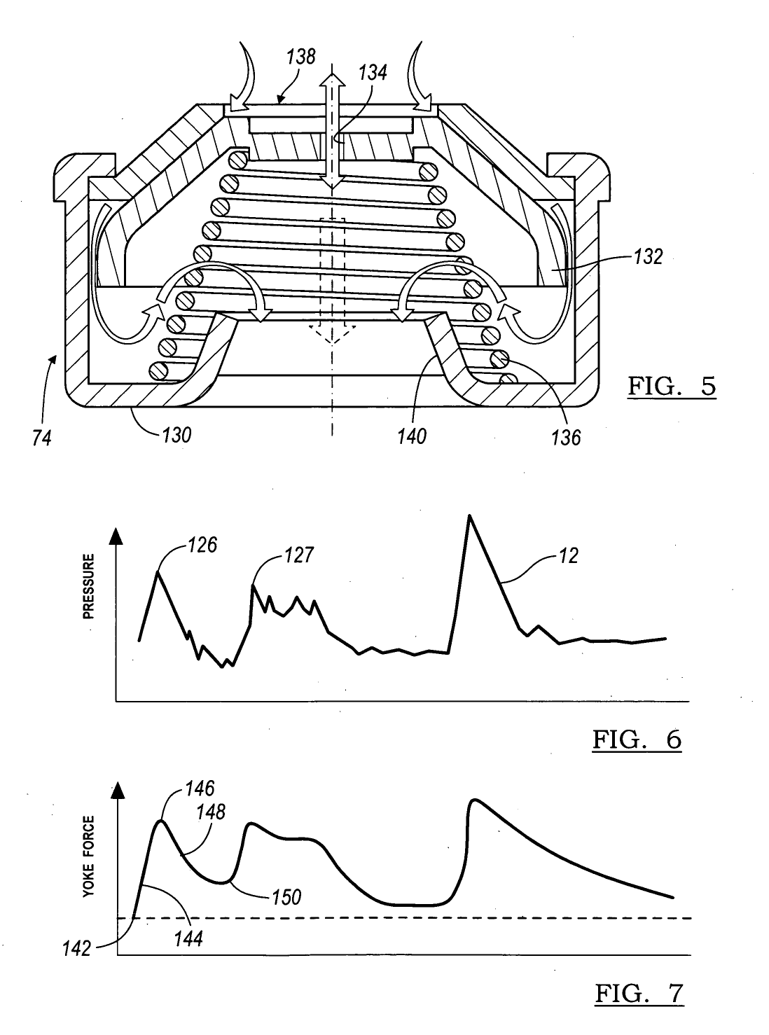

A control valve 74, preferably located in line 68, regulates the time rate of increase and decrease of pressure in chamber 26, as described below with reference to FIGS. 5-7. The connection between line 68 and chamber 26 is sealed against the passage of fluid by an O-ring 76, seated in yoke 28 and elastically contacting in the inner surface of main housing section 18, and by an O-ring 78, seated in plug 20 and elastically contacting the inner surface of the main housing section.

Pressurized fluid in chamber 26 applies a pressure force to the annular surface 80 of the yoke 28, which force adds to the spring force tending to urge rack 12 into engagement with the teeth 54 of the pinion 14. The magnitude of the force is equal to the product of the pressure times the area to which the pressure is applied.

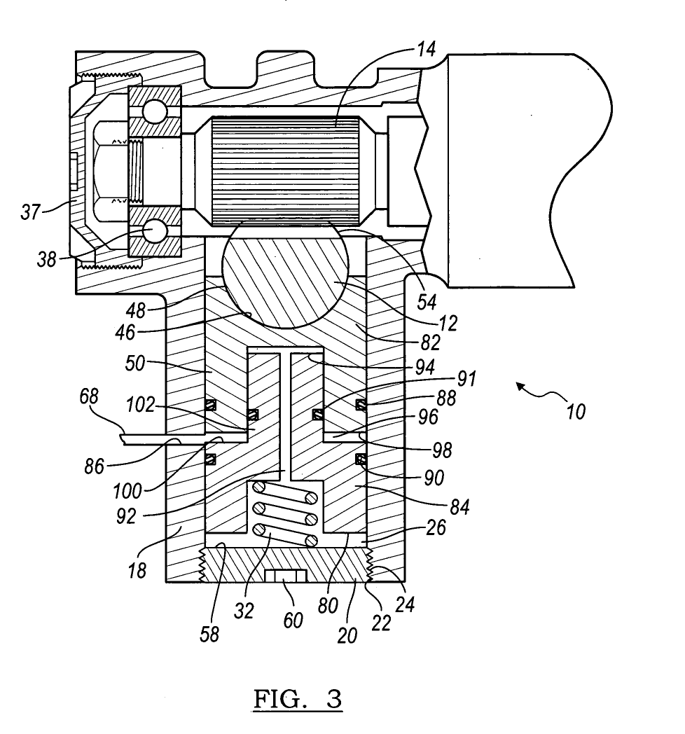

Referring now to FIG. 3, the yoke is formed in two portions, an axial inner portion 82, whose surface 46 contacts the rack 12, and an axially outer portion 84, which contacts the spring 32. The conduit 86 formed in the wall of housing 18 and connected to line 68 is sealed against the passage of fluid by an O-ring 88, seated in the inner yoke portion 82 and elastically contacting in the inner surface of main housing section 18, and by an O-ring 90, seated in the outer yoke portion 84 and elastically contacting the inner surface of the main housing section. A third O-ring 91 is seated in the inner yoke portion 82 and elastically contacts the outer yoke portion. An axial duct 92 communicates a space 94 at the inner end of yoke portion 84 to the end of the yoke portion 84.

Pressurized fluid in the annular space 96 between yoke portions 82, 84 applies a pressure force to the annular surface 98, which adds to the spring force tending to urge rack 12 into engagement with the teeth 54 of the pinion 14. Pressurized fluid in the annular space 96 also applies a pressure force to the annular surface 100, which opposes the spring force tending to urge rack 12 into engagement with the teeth 54 of the pinion 14. The magnitude of the pressure force on surface 98 can be increased by increasing the area of surface 98 and reducing the diameter of the projection 102 on yoke portion 84, which extends into yoke portion 82. The magnitude of the pressure force on surface 98 can be decreased by decreasing the area of surface 98 and increasing the diameter of projection 102.

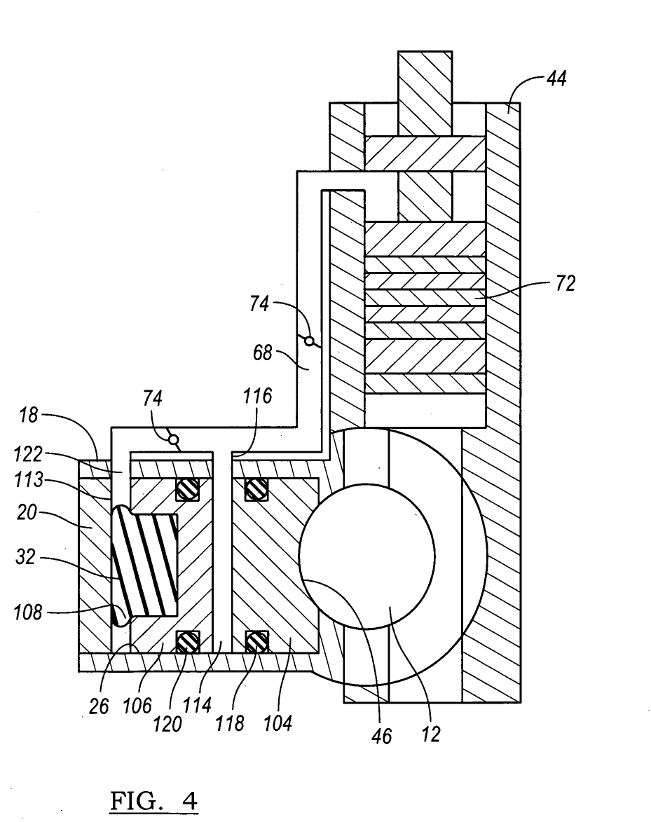

FIG. 4 illustrates a two-piece yoke 102 comprising an axial inner portion 104, whose surface 46 contacts the rack 12, and an axially outer portion 106 having a recess 108 containing an elastic member 32, such as a helical coiled spring, wave spring or elastomeric member. The yoke is formed with an annular recess 114, which communicates with line 68 through a conduit 116 formed in the wall of housing 18. The conduit 116 is sealed at opposite axial sides against the passage of fluid by an O-ring 118, seated in the yoke portion 104 and elastically contacting in the inner surface of main housing section 18, and by an O-ring 120 seated in the yoke portion 106 and elastically contacting the inner surface of the main housing section. Line 68 extends to the end of yoke portion 106 and communicates with a recess 113 formed in yoke 106 adjacent plug 20 through a radial passage 122 formed through the wall of housing 18.

Pressurized fluid in the annular recess 122 applies a pressure force, which adds to the spring force tending to urge rack 12 into engagement with the teeth 54 of the pinion 14. Pressurized fluid in the recess 114 also applies to the yoke portion 106 a pressure force, which opposes the spring force. However, a pressure force applied to the axial end face of recess 122 is equal to the pressure force tending to oppose the spring force. Pressurized fluid in recess 122, therefore, applies a pressure force to the annular surface 26 of yoke portion 106, which force adds to the spring force tending to urge rack 12 into engagement with the teeth of the pinion 14. This provides additional control to dampen movement.

FIG. 5 illustrates an example of a valve 74 that regulates the time rate of increase and decrease of pressure in the yoke chamber 26. FIG. 6 illustrates transient pressure changes 126 in line 68 upstream from valve 74 caused by road events. FIG. 7 illustrates the variation over time of the magnitude of pressure forces applied to the yoke when pressure downstream of valve 74 is regulated by the valve.

Valve 74 includes a cage 130 containing a control element 132 formed with a central orifice 134, and a compression spring 136, which urges the control element toward a seated position on the cage, the position shown in FIG. 5. Road events produce a transient pressure increase 126 at the inlet 138 of valve 74. That pressure compresses spring 136, unseats element 132, and allows fluid to flow around the outer periphery of element 132 and through orifice 134 to the outlet 140, from which fluid flows through line 68 to the yoke chamber 26.

In FIG. 7, valve 74 opens at 142 due to pressure transient 126, the pressure force on the yoke increases along ramp 144, and the valve closes at 146. Thereafter, the yoke pressure force decreases along ramp 148 in accordance with the size of orifice 134 and leakage past the valve 74, until the next road event 127, whereupon valve 74 again opens at 150. The total force on the yoke is the sum of the pressure force and the force produced by spring 32.

The dynamic forces on the yoke bearing are applied when the rack is subjected to impulse movement. The increased forces on the yoke bearing also increase the normalized friction to negate or minimize the effects of the positional movement impulse. This also improves the feel of the steering system to the vehicle operator.

In accordance with the provisions of the patent statutes, the preferred embodiment has been described. However, it should be noted that the alternate embodiments can be practiced otherwise than as specifically illustrated and described.

What is claimed is:

1. An apparatus for urging components of a power steering system for a motor vehicle into mutual engagement comprising:
a rack including gear teeth;
a pinion including gear teeth engaged with the gear teeth of the rack;
a yoke bearing contacting the rack;
a spring resiliently contacting the yoke and urging the rack into engagement with the pinion;
a source of variable hydraulic pressure communicating with the yoke bearing and applying to the yoke bearing a force that urges the rack into engagement with the pinion; and
a valve that opens a connection between the pressure source and the yoke bearing at a first speed in response to a first pressure magnitude at the pressure source and that closes said connection at a second speed slower than the first speed when pressure at the pressure source decreases relative to the first pressure magnitude.

2. The apparatus of claim 1 further comprising:
a housing containing the yoke bearing and the spring;
a chamber located in the housing;
a plug secured to the housing for closing the chamber;
a passage through a wall of the housing for communicating the chamber and the pressure source;
a first seal for preventing passage of fluid between the yoke bearing and the housing; and
a second seal for preventing passage of fluid between the plug and the housing.

3. The apparatus of claim 1 further comprising:
a housing containing the spring;
a first yoke bearing portion located in the housing, contacting the rack and including a first pressure area facing the rack;
a second yoke bearing portion located in the housing, contacting the spring, and displaceable toward and away from contact with the first yoke bearing portion;
a plug secured to the housing for closing the housing;
a passage through a wall of the housing for communicating the first pressure area and the pressure source;
a first seal for preventing passage of fluid between the first yoke bearing portion and the housing;
a second seal for preventing passage of fluid between second yoke bearing portion and the housing; and
a third seal for preventing passage of fluid between first and second yoke bearing portions.

4. The apparatus of claim 1 further comprising:
a housing containing the spring;
a first yoke bearing portion located in the housing, contacting the rack and including a first pressure area facing the rack;
a second yoke bearing portion located in the housing, contacting the spring, displaceable toward and away from contact with the first yoke bearing portion, including a second pressure area facing away from the rack, and third pressure area facing the rack;
a plug secured to the housing for closing the housing;
a passage through a wall of the housing for communicating the pressure source to the first, second and third pressure areas;
a first seal for preventing passage of fluid between the first yoke bearing portion and the housing; and
a second seal for preventing passage of fluid between second yoke bearing portion and the housing.

5. The apparatus of claim 1 wherein the yoke bearing applies a relative high magnitude of force resisting displacement of the rack away from the pinion and a lower magnitude of force urging displacement of the rack toward the pinion.

6. The apparatus of claim 1 wherein the valve includes:
an inlet and an outlet;
a cage having a seat;
a control element located in the cage and moveable to seated engagement with the cage thereby opening a connection between the inlet and outlet, and moveable out of said engagement to an unseated position thereby closing a connection between the inlet and outlet; and
a second spring located in the cage, for urging the control element toward seated engagement with the cage.

7. The apparatus of claim 6 wherein the control element further includes:
an orifice that partially opens a connection between the inlet and outlet when the control element is seated on the cage.

8. The apparatus of claim 6 wherein the control element moves in the cage in response to a pressure differential across the control element and a force produced by the second spring.

9. An apparatus for urging components of a power steering system for a motor vehicle into mutual engagement comprising:
a rack including gear teeth;
a pinion including gear teeth engaged with the gear teeth of the rack;
a first yoke bearing portion contacting the rack and including a first pressure area facing the rack;
a second yoke bearing portion displaceable toward and away from contact with the first yoke bearing portion including a second pressure area facing away from the rack;
a spring resiliently contacting the second yoke bearing portion and urging the rack into engagement with the pinion;
a source of variable hydraulic pressure communicating with the first and second pressure areas and applying to the first pressure area a force that urges the rack into engagement with the pinion; and
a valve that opens a connection between the pressure source and the first and second pressure areas at a first speed in response to a first pressure magnitude at the pressure source, and that closes said connection at a second speed slower than the first speed when pressure at the pressure source decreases relative to the first pressure magnitude.

10. The apparatus of claim 9, further comprising:
a housing;
a first seal for preventing passage of fluid between the first yoke bearing portion and the housing;
a second seal for preventing passage of fluid between second yoke bearing portion and the housing; and
a third seal for preventing passage of fluid between first and second yoke bearing portions.

11. The apparatus of claim 9 wherein the valve includes:
an inlet and an outlet;
a cage having a seat;
a control element located in the cage and moveable to seated engagement with the cage thereby opening a connection between the inlet and outlet, and moveable out of said engagement to an unseated position thereby closing a connection between the inlet and outlet; and
a second spring located in the cage, for urging the control element toward seated engagement with the cage.

12. The apparatus of claim 9 wherein the control element further includes:
an orifice that partially opens a connection between the inlet and outlet when the control element is seated on the cage.

13. The apparatus of claim 9 wherein the control element moves in the cage in response to a pressure differential across the control element and a force produced by the second spring.

14. An apparatus for urging components of a power steering system for a motor vehicle into mutual engagement comprising:
a rack including gear teeth;
a pinion including gear teeth engaged with the gear teeth of the rack;
a first yoke bearing portion contacting the rack and including a first pressure area facing the rack;
a second yoke bearing portion displaceable toward and away from contact with the first yoke bearing portion including a second pressure area facing away from the rack, and a third pressure area facing the rack;
a spring resiliently contacting the second yoke bearing portion and urging the rack into engagement with the pinion;
a source of variable hydraulic pressure communicating with the first, second and third pressure areas and applying to the first and second pressure areas forces that urge the rack into engagement with the pinion; and
a valve that opens a connection between the pressure source and the first and second pressure areas at a first speed in response to a first pressure magnitude at the pressure source, and that closes said connection at a second speed slower than the first speed when pressure at the pressure source decreases relative to the first pressure magnitude.

15. The apparatus of claim 14 further comprising:
a housing;
a first seal for preventing passage of fluid between the first yoke bearing portion and the housing; and
a second seal for preventing passage of fluid between second yoke bearing portion and the housing.

16. The apparatus of claim 14 wherein the valve includes:
an inlet and an outlet;
a cage having a seat;
a control element located in the cage and moveable to seated engagement with the cage thereby opening a connection between the inlet and outlet, and moveable out of said engagement to an unseated position thereby closing a connection between the inlet and outlet; and
a second spring located in the cage, for urging the control element toward seated engagement with the cage.

17. The apparatus of claim 16 wherein the control element further includes:
an orifice that partially opens a connection between the inlet and outlet when the control element is seated on the cage.

18. The apparatus of claim 16 wherein the control element moves in the cage in response to a pressure differential across the control element and a force produced by the second spring.
